(19) United States
(12) Patent Application Publication
(10) Pub. No.: US 2016/0018432 A1
(43) Pub. Date: Jan. 21, 2016

(54) Handheld Tachometer

(71) Applicant: Yu-Sheng Lin, Taipei City (TW)

(72) Inventor: Yu-Sheng Lin, Taipei City (TW)

(21) Appl. No.: 14/333,514

(22) Filed: Jul. 17, 2014

(51) Int. Cl. G01P 3/486

(52) U.S. Cl. CPC G01P 3/486

(57) ABSTRACT

The present invention is a handheld tachometer characterized in a unity body provided with a contact type tachometer, a non-contact type optical tachometer and a stroboscope such that the handheld tachometer can be used in different applications for measuring a machinery rotating speed. The handheld tachometer includes a unity body having one end provided with a contact shaft of the contact type tachometer and the other end provided with the non-contact type optical tachometer and stroboscope together with a display driver, a switch button and a set of function switch for controlling and switching an operational function. Thereby the handheld tachometer with multiply functions is ready to be used on different objects so as to achieve the convenience in measuring a machinery rotating speed in the most suitable manner and thus enhance the practical value.

### TECHNICAL FIELD OF THE INVENTION

The present invention is related to a tachometer for measuring a machinery rotating speed, particularly a handheld type tachometer.

### DESCRIPTION OF THE PRIOR ART

The current art of measuring a machinery rotating speed can be categorized as contact type and non-contact type. The contact type measurement uses an instrument called contact type tachometer while the non-contact type measurement uses instruments like optical tachometer and stroboscope. Both principles and applications of aforesaid both type instruments are so different that usually only one instrument can be applied on a specific application. Therefore users of tachometers and stroboscope are under limitations that in general they have to purchase different types of tachometers and stroboscope in order to measure the rotating speed of different machinery that the measurement of machinery rotating speed becomes non-economical in terms of field applications. Therefore there is a demand for an instrument convenient to use in different field applications.

### SUMMARY OF THE INVENTION

An objective of the present invention is to provide a handheld tachometer with multiply functions of contact type and non-contact type measurement such that one tachometer can be used in different applications for measuring a machinery rotating speed.

The present invention for achieving the above-mentioned objective is a handheld tachometer in a form of a unity body. A contact type tachometer is provided within one end of the unity body having a contact shaft positioned outside the unity body for measuring a rotating speed in a contact manner with a friction surface of the contact shaft incorporation with a pulse shaping to show a reading on a display driver at the unity body through a digital display and a micro-controller.

An opening is configured at the other end of the unity body that an optical tachometer and a stroboscope are installed inside with both a photo tach lighting source of the optical tachometer and a stroboscope lighting source of the stroboscope exposed outside for projecting the flash lights outward through the opening for measuring a rotating speed in a non-contact manner. The optical tachometer projects a flash light as driven by a built-in lighting source driver through the photo tach lighting source along a longitudinal direction at a pre-set angle that a reflective light is detected by a photo detector pickup of the optical tachometer in corporation with a built-in pulse shaping to show a reading at the display driver at the unity body through the digital display and micro-controller. The stroboscope proceeds with a flash synchronous frequency measurement under a function of a stroboscope flashing light select switch, a stroboscope lighting source driver and a stroboscope lighting source as built-in within the stroboscope in corporation with a frequency synthesis circuit to show a reading at the display driver at the unity body through the digital display and micro-controller.

### BRIEF DESCRIPTION OF THE DRAWINGS

FIG. 1 is a component layout diagram of the present invention.

FIG. 2 is a side view diagram on a lateral end of the present invention.

FIG. 3 is a side view diagram on a top end of the present invention.

FIG. 4 is a block diagram illustrating an electrical circuit function of the present invention.

### DETAILED DESCRIPTION OF THE PREFERRED EMBODIMENTS

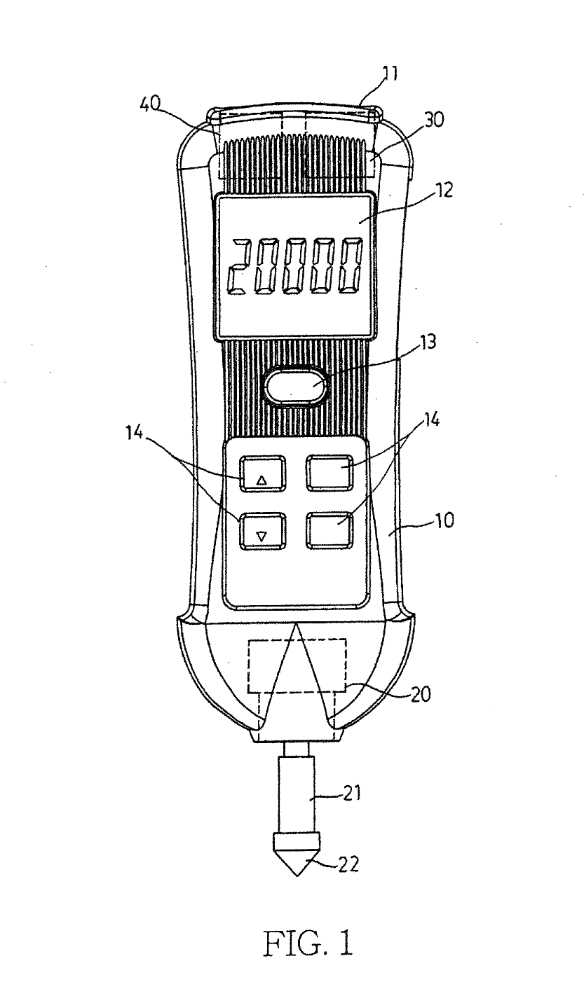

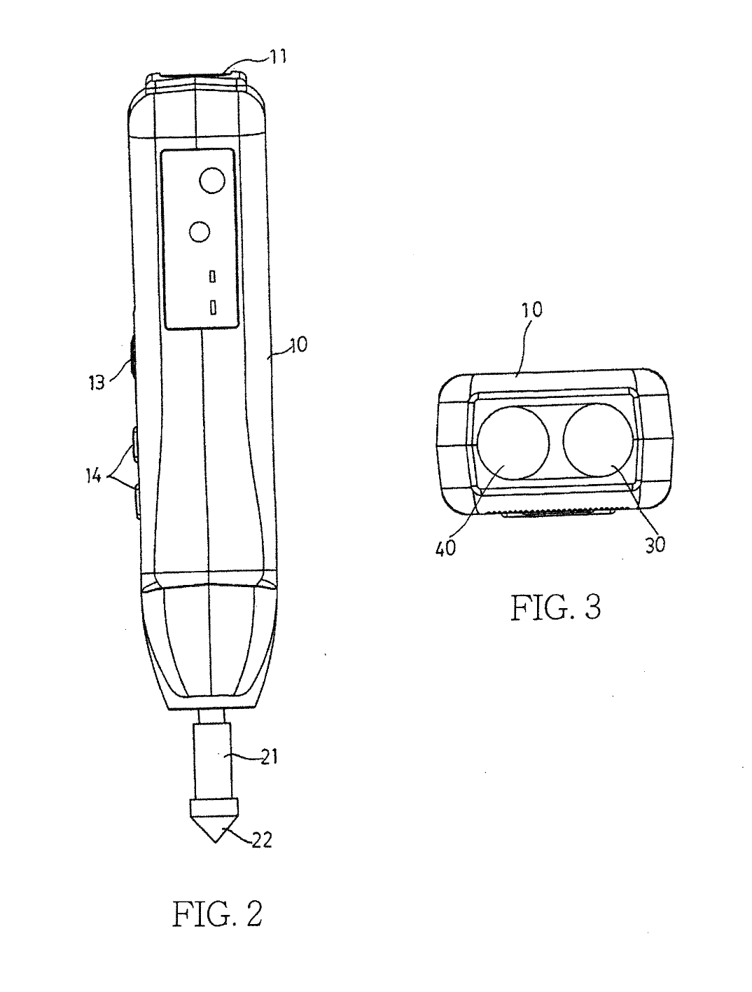

Please refer FIG. 1 to FIG. 3. A handheld tachometer of the present invention mainly includes an unity body (10) having one end within which a contact type tachometer (20) is provided while a contact shaft (21) of the contact type tachometer (20) is positioned outside the unity body (10) and configured with a friction surface of conical shape (22) at a tip of the contact shaft (21) so as to utilize the friction surface of conical shape (22) for measuring a machinery rotating speed in a contact manner. The other end of the unity body (10) is provided with an opening (11) while an optical tachometer (30) and a stroboscope (40) are installed inside the unity body (10) while both lighting sources of the optical tachometer (30) and the stroboscope (40) are exposed outside the opening (11) in order to project their flash lights outward through the opening (11) for measuring a machinery rotating speed in a non-contact manner. A front surface of the unity body (10) is provided with a display driver (12), a switch buttons (13) and a set of necessary function switch (14) in order to control and switch an operational function of the handheld tachometer. Thereby the handheld tachometer with multiply functions is ready to be used on different measured objects so as to achieve the convenience in measuring a machinery rotating speed in the most suitable manner and thus enhance the practical value of the handheld tachometer.

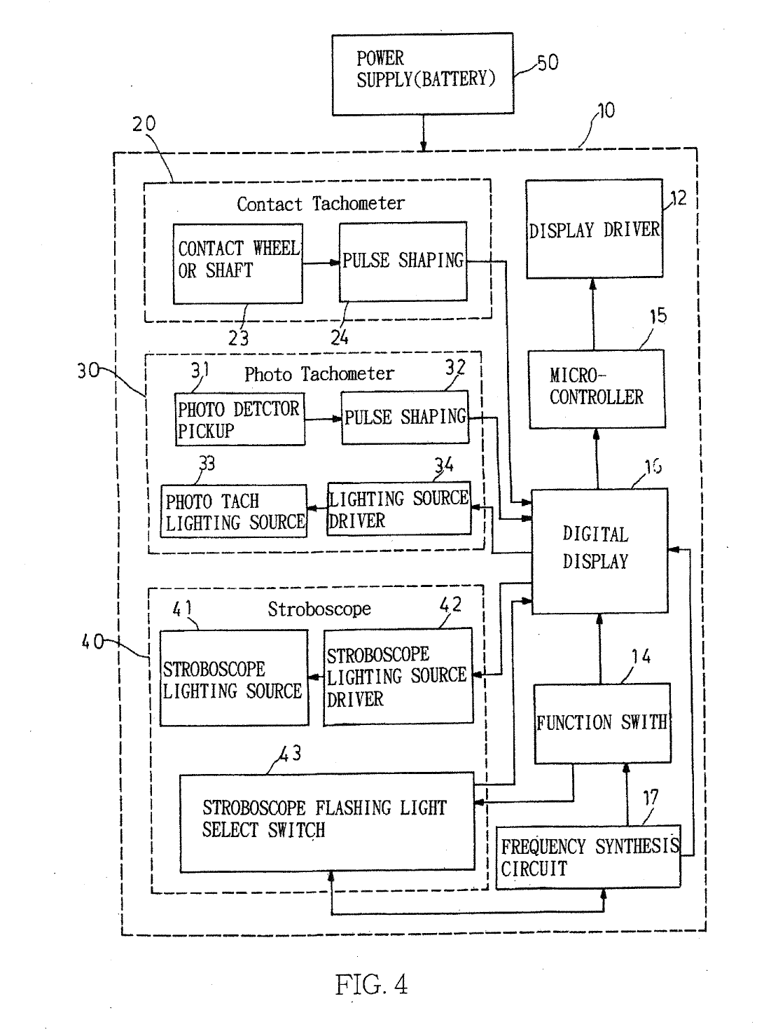

FIG. 4 is a block diagram illustrating an electrical circuit function of the present invention. A power supply (50) consisted of battery supplies direct current to all demanding components within the unity body (10). The contact type tachometer (20) utilizes a contact wheel or shaft (23) for measuring a machinery rotating speed in a contact manner in corporation with a built-in pulse shaping (24) to show a reading at the display driver (12), which is provided at the front surface of the unity body (10), through a digital display (16) and a micro-controller (15) that are positioned inside the unity body (10). The optical tachometer (30) projects a flash light as driven by a built-in lighting source driver (34) through a photo tach lighting source (33) along a longitudinal direction at a pre-set angle. Then a photo detector pickup (31) of the optical tachometer (30) detects a reflective light from a reflection pad, which is positioned on a measured object, in corporation with a built-in pulse shaping (32) to show a reading at the display driver (12) at the front surface of the unity body (10) through the digital display (16) and the micro-controller (15). The stroboscope (40) proceeds with a flash synchronous frequency measurement of a mark, which is positioned on a measured object, under a function of a stroboscope flashing light select switch (43), a stroboscope lighting source driver (42) and a stroboscope lighting source (41), which are built-in within the stroboscope (40), in corporation with a frequency synthesis circuit (17) to show a reading at the display driver (12) at the front surface of the unity body (10) through the digital display (16) and the micro-controller (15).

I claim:

1. A handheld tachometer comprising an unity body, within one end of said unity body provided with a contact type tachometer utilizing a contact shaft positioned outside said unity body for measuring a rotating speed in a contact manner, at the other end of said unity body configured with an opening having an optical tachometer and a stroboscope installed inside with a photo tach lighting source of the optical tachometer and a stroboscope lighting source of the stroboscope exposed outside for projecting a flash light of both the optical tachometer and the stroboscope through the opening outward for measuring a rotating speed in a non-contact manner and at front surface of said unity body provided with a display driver, a switch button and a set of function switch for controlling and switching an operational function of said handheld tachometer.

2. The handheld tachometer of claim 1 wherein a friction surface of conical shape is configured at a tip of the contact shaft of the contact type tachometer for measuring the rotating speed in a contact manner.

3. A handheld tachometer comprising an unity body, a power supply installed inside said unity body for supplying direct current to all demanding components, within one end of said unity body provided with a contact type tachometer utilizing a contact shaft or wheel for measuring a rotating speed in a contact manner in corporation with a built-in pulse shaping to show a reading at a display driver provided at a front surface of said unity body through a digital display and a micro-controller positioned inside said unity body, at the other end of said unity body configured with an opening having an optical tachometer and a stroboscope installed inside that the optical tachometer projecting a flash light driven by a built-in lighting source driver through a photo tach lighting source along a longitudinal direction at a pre-set angle as a photo detector pickup of the optical tachometer detecting a reflective light from a reflection pad positioned on a measured object in corporation with a built-in pulse shaping to show a reading at the display driver provided at the front surface of said unity body through the digital display and the micro-controller positioned inside said unity body while the stroboscope proceeding with a flash synchronous frequency measurement of a mark positioned on a measured object under a function of a stroboscope flashing light select switch, a stroboscope lighting source driver and a stroboscope lighting source as built-in within the stroboscope in corporation with a frequency synthesis circuit to show a reading at the display driver provided at the front surface of said unity body through the digital display and the micro-controller positioned inside said unity body.
